(19) United States
(12) Patent Application Publication
(10) Pub. No.: US 2022/0227664 A1
(43) Pub. Date: Jul. 21, 2022

(54) DECORATIVE GLASS ELEMENT AND PROCESS FOR PRODUCING SAME

(71) Applicant: AGC GLASS EUROPE, Louvain-la-Neuve (BE)

(72) Inventors: Thomas LAMBRICHT, Perwez (BE); Cécile MUSIALSKI, Gosselies (BE); Charlotte JACOB, Gosselies (BE)

(73) Assignee: AGC GLASS EUROPE, Louvain-la-Neuve (BE)

(21) Appl. No.: 17/617,066

(22) PCT Filed: Jun. 9, 2020
(86) PCT No.: PCT/EP2020/065900

§ 371 Date: Dec. 7, 2021

(30) Foreign Application Priority Data
Jun. 11, 2019 (EP) 19179476.7

(51) Int. Cl. C03C 17/32; C03C 17/30

(52) U.S. Cl. CPC C03C 17/322; C03C 17/324; B33Y 10/00; C03C 17/30; C03C 2217/72; C03C 17/326

(57) ABSTRACT

A decorative glass element including a transparent glass substrate with an outer surface exposed to an outer environment and separated from an inner surface by a substrate thickness, a structured coating made of a transparent polymer that is applied over all or part of the inner surface of the transparent glass substrate to form a coated substrate and a structured free surface with an R_{Z} roughness between 0.1 and 4 mm, and a base support coupled to the coated substrate with an interior surface facing with or without contact the free surface of the structured coating and protecting the free surface from direct access from the outer environment.

### TECHNICAL FIELD

The present invention is in the field of decorative glass elements, in particular used in the fields, e.g., of vehicle decoration (interiors, exterior trims, and windows), and of the building industry (both interior and exterior). The present invention proposes a cost-effective solution for creating a visual aspect of cut-glass, which eliminates the skills- and labour-intensive step of cutting a glass surface according to a predefined decorative pattern. The present invention provides a solution for industrially producing decorative glass elements, having the durability and resistance to abrasion of glass, and yet which can be produced in series.

### BACKGROUND OF THE INVENTION

Crystal and cut-glass decorative items are well known and appreciated for the richness of the decorative effect obtained therewith. Bohemian crystal, Murano (Venice) glass have become common names to designate such decorative glass/crystal items. The cost of such items is related to the time and skills required for producing one such item at a time, as industrialisation of such items is difficult, if not impossible.

Recently, there has been a demand from the luxury automotive industry to include cut-glass or cut-glass-like decorative elements in the interior of luxury vehicles, or even integrated in the windscreen or other windows of such vehicles. In the transportation industry, cost clearly is a key driver, but safety aspects are paramount. It would be unacceptable to include a glass decorative element in the interior of a vehicle which could shatter and fly all over the interior of the vehicle in case of impact, endangering the occupants of the vehicle.

To address the safety aspects required in the transportation industry, it has been proposed to cut a first main surface of a glass plate according to a decorative pattern, apply a polymeric safety film on a second main surface of the plate, opposite the first surface, and to integrate the thus obtained glass decorative element in e.g., a portion of a dashboard in an interior of a vehicle with the first surface contacting the dashboard, and the second surface covered by the polymeric safety film being exposed to the interior of the vehicle, freely accessible to the occupants of the vehicle. The polymeric safety film exposed to the interior of the vehicle prevents the glass plate from shattering and flying in the interior of the vehicle in case of impact and retains the integrity of the glass plate. This solution solves the problem of safety but remains very expensive because of the labour-intensive operation of cutting the glass. Such glass decorative elements remain restricted to luxury vehicles. Furthermore, a protective film applied to the second surface is easily scratch and gives a cheap feeling at the touch, which is not appropriate for luxury cars.

An alternative method for producing a glass element looking like a cut-glass crystal-like item is to hot-mould the element by casting molten glass into a mould. This method, though more economical than cutting a pattern into the glass surface, remains quite expensive because of the high temperatures the moulds must withstand with molten glass (over 1000° C.), therefore limiting the sizes of the moulds.

The present invention proposes a solution for producing a decorative glass element looking like a cut-glass item and requiring no skills- nor labour-intensive glass-cutting step. The glass decorative elements of the present invention can be produced industrially; and give an aspect very close to real cut-glass elements, with an exposed surface which is smooth and thus easy to clean and has the durability of glass. The glass decorative elements can easily satisfy all safety requirements for their use in the transportation industry, but also in the building industry, both for interior and exterior decoration. New decorative effects can be explored with the present invention

### SUMMARY OF THE INVENTION

The present invention concerns a decorative glass element comprising,
(a) a glass substrate,
   having a refractive index (n1),
   comprising an outer surface exposed to an outer environment and being separated from an inner surface by a substrate thickness (t1), and
   being transparent to visible light with a substrate transmission (T1) across the substrate thickness of at least 30%, wherein the transmission is measured according to EN410-2011 with a D-illuminant and a solid angle of observation of 2°,
(b) a structured coating,
   applied over all or part of the inner surface of the glass substrate, forming an interface with the inner surface of the glass substrate, and comprising a free surface separated from the interface by a coating thickness having a mean coating thickness (t2), and thus forming with the glass substrate a coated substrate, wherein
   the free surface has an Rz-roughness comprised between 0.1 and 4 mm,
   the structured coating is made of a polymer, wherein the polymer,
      has a refractive index (n2) differing from the refractive index (n1) of the glass substrate by not more than 0.2 (i.e., βn2−n1|≤0.2) and
      has a mean coating attenuation coefficient (a) of not more than 5000 m⁻¹ (i.e., a ≤5000 m⁻¹), wherein the mean coating attenuation is an average measured between 380 and 780 nm,
(c) a base support coupled to the coated substrate, comprising an interior surface facing with or without contact the free surface of the structured coating, and protecting the free surface from direct access from the outer environment.

The substrate thickness (t1) can be comprised between 0.4 and 2 mm, preferably, between 0.5 and 1.5 mm, more preferably between 0.6 and 1.2 mm. The mean coating thickness (t2) can be comprised between 0.1 and 4 mm, preferably between 0.5 and 3.5 mm, more preferably between 1 and 2.5 mm. A ratio t2/t1 of the mean coating thickness (t2) to the substrate thickness (t1) can be comprised between 0.05 and 10, more preferably between 0.5 and 8, most preferably between 1 and 6, or even between 2 and 5. The ratio t2/t1 is preferably greater than 0.2, more preferably greater than 0.5, more preferably greater than 0.8, and most preferably greater than 1.

Very thin structures can be obtained by using a glass substrate preferably flat and having a substrate thickness (t1) comprised between 0.4 and 2 mm. In this embodiment, the glass substrate can be chemically strengthened and/or can be a laminated glass comprising at least a polymeric lamina sandwiched between two glass laminae of the type used in safety glasses in automotive vehicles. Typical polymeric laminae include PVB, EVA, PU.

For applications submitted to safety regulations, the outer surface (1o) or the inner surface (1i) of the glass substrate can be covered by a polymeric protective layer, for preventing shattering of the glass substrate in case of impact.

The polymer forming the structure surface can be selected for example among a polyester, a (poly)acrylic, an epoxy, a polyurethane, a polycarbonate, a silicone, or mixtures or copolymers thereof. Some examples of suitable transparent polymers with their indices of refraction (n2) are listed in the Table below.

| | Transmission [%] | Refractive Index, n2 |
|---|---|---|
| PC | 86-91 | 1.584-1.586 |
| PMMA | 89-92 | 1.49 |
| PET | 87-92.1 | 1.575 |
| PETG | 92 | 1.55 |
| Clear PVC | Up to 97% | 1.381 |
| LSR | 94 | 1.41 |
| COC | 91 | 1.53 |
| LDPE | 4.4-94 | 1.476 |
| Ionomer Resin | 93.4 | 1.49 |
| Transparent PP | — | 1.347 |
| FEP | 92 | 1.55 |
| SMMA | 89-92.8 | 1.59 |
| SAN | 86.2-89.3 | 1.57 |
| GPPS | 88-90 | 1.6 |
| Transparent ABS | 86 | 1.52 |

The free surface of the structured coating can be coated with a reflective or coloured coating. The coloured coating can be opaque or transparent to visible light. A coloured pattern and/or a reflective pattern can be applied on a surface of the decorative glass element, wherein the surface is selected from:
the inner surface of the glass substrate or
a surface of a glass lamina of a laminated glass substrate comprising at least a polymeric lamina sandwiched between two glass laminae, or
the free surface of the structured coating,
the interior surface of the base support, or
combinations thereof.

The base support can be made of polymer, glass, metal, leather, wood, or combinations thereof. If the base support is made of polymer, it can be cast over the free surface of the structured coating so that the interior surface forms an interface with the free surface of the structured coating and with any portion of the inner surface of the glass substrate which is not covered by the structured coating.

In an alternative embodiment, the interior surface of the base support does not contact or contacts only a portion of the free surface of the structured coating, and is coupled to a peripheral edge of the glass substrate and/or to a portion of the inner or outer surface of the glass substrate.

The present invention also concerns a process for producing a decorative glass element as described supra, comprising the following steps:
(a) providing a glass substrate as defined supra
(b) applying a structured coating as defined supra onto part or all of the inner surface of the glass substrate to form a coated substrate and, simultaneously or subsequently, forming a structured pattern on the free surface of the structured coating, having an Rz-roughness comprised between 0.1 and 4 mm,
(c) coupling a base support as defined supra to the coated substrate, such that the interior surface faces the free surface of the structured coating and protects the free surface from direct access from the outer environment.

Application of a structured coating (=step (b)) can be performed,
by 3-D printing of the structured pattern onto the inner surface of the glass substrate, or
by laminating and embossing a polymer layer over the inner surface of the glass substrate.

The base support can be made of a base polymer which can be cast in liquid state over the free surface of the structured coating and over any portion of the inner surface of the glass substrate which is not covered by the structured coating. The base polymer is made to solidify by cooling if the base polymer is a thermoplastic, or by curing if the base polymer is a thermoset resin or an elastomer.

The base support can be coupled to a peripheral edge of the glass substrate and/or to a portion of the inner or outer surface of the glass substrate, and/or to at least a portion of the free surface of the structured coating. Coupling can be carried out by gluing, welding, or mechanically.

In one embodiment, the decorative glass element can be permanently bent by cold bending upon coupling to the base support.

The decorative glass element of the present invention can be used as a decorative component forming or integrated in one of,
a vehicle, preferably of an interior of an automotive vehicle,
a building,
a drinking glass, a bottle, a jar or a pot,
an electrical appliance, preferably in a display or a control panel.

### BRIEF DESCRIPTION OF THE FIGURES

For a fuller understanding of the nature of the present invention, reference is made to the following detailed description taken in conjunction with the accompanying drawings in which:

FIG. 1: illustrates various steps for producing a decorative glass element according to the present invention.

FIG. 2: shows two embodiments of structured coatings applied over a glass substrate and prior to coupling a base support thereto, (a) partial coating of the inner surface and (b) coating of the whole of the inner surface with grooves forming a pattern.

FIG. 3: shows two embodiments of decorative patterns obtainable with a decorative glass element according to the present invention.

FIG. 4: shows two embodiments for applying a structured coating over the inner surface of the glass substrate, (a) by 3-D-printing and (b) by embossing a polymeric layer.

FIG. 5: shows how Rz-roughness is measured.

### DETAILED DESCRIPTION OF THE INVENTION

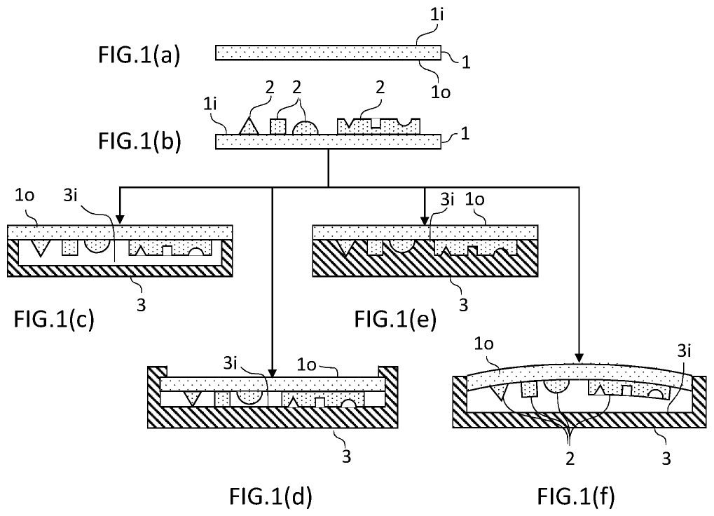

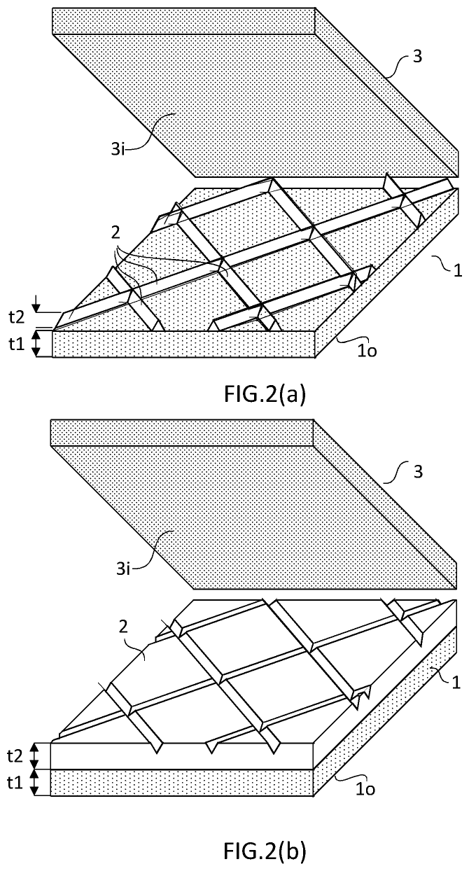

As illustrated in FIGS. 1 and 2, the present invention concerns a decorative glass element comprising:
(a) A glass substrate (1) comprising an inner surface (1i),
(b) A structured coating (2) applied over the inner surface (1i) to form a coated substrate, and
(c) A base support (3) coupled to the coated substrate, comprising an interior surface facing the structured coating of the coated substrate.

The various components of the decorative glass element of the present invention are described more in detail below.

### Glass Substrate (1)

The glass substrate (1) comprises an inner surface (1i) separated from an outer surface (1o) by a thickness (t1) of the glass substrate and bounded by a peripheral edge.

The thickness (t1) of the glass substrate is preferably substantially constant, but it can also vary between different portions thereof. There is no real limitation to the thickness (t1) of the glass substrate, but for cost reasons and, in many applications, such as in transportation, weight can be an issue. For these reasons, the thickness (t1) is preferably comprised between 0.4 and 2 mm, preferably, between 0.5 and 1.5 mm, more preferably between 0.6 and 1.2 mm, or even between 0.7 and 1.0. The inner surface of the glass substrate is preferably flat during the application of the structured coating over the inner surface, but can be curved afterwards, e.g., by cold bending, as described below when discussing processes for producing the decorative glass element of the present invention.

The glass substrate must be transparent to visible light. The substrate can have a substrate transmission (T1) across the substrate thickness of at least 30%, wherein the transmission is measured according to EN410-2011 with a D-illuminant and a solid angle of observation of 2°. It has a refractive index, n1. The glass substrate can have a higher substrate transmission (T1) of at least 40%, preferably at least 50%, more preferably at least 60%, most preferably at least 70%. The transmission (T1) can even be higher than 80% or 90%. The choice of a given transmission can depend on the required application and on the sought decorative effect, as long as the structured coating is still at least partially visible through the thickness of the glass substrate.

Some applications, like displays, require a glass substrate of very low thickness t1 (e.g., 0.4<t1<2 mm), and high mechanical resistance. The glass substrate can be thinner and yet yield high mechanical resistance if it is chemically strengthened. For example, it is well known in the art to strengthen a soda containing glass by ion exchange in a salt bath containing potassium-salts. Typical glass compositions suitable for chemical tempering are: sodalime silicate, aluminosilicate, borosilicate, boro-aluminosilicate, lithium-aluminosilicate, and the like.

To address the safety aspects required e.g., in the transportation industry, the glass substrate can be a laminated glass comprising at least a polymeric lamina, such as PVB, EVA, PU, or a ionomer, sandwiched between two glass laminae.

The glass substrate can be treated by any technique known and required depending on the applications.

According to one embodiment of the invention, the glass substrate is coated with at least one transparent and electrically conducting thin layer. A transparent and conducting thin layer according to the invention can, for example, be a layer based on SnO₂:F, SnO₂:Sb or indium tin oxide (ITO), ZnO:Al or also ZnO:Ga.

According to another embodiment of the invention, the glass substrate is coated with at least one antireflection layer. This embodiment is obviously advantageous in the case of use of the glass substrate of the invention as front face of a screen. An antireflection layer according to the invention can, for example, be a layer based on porous silica having a low refractive index or it can be composed of several layers (stack), in particular a stack of layers of dielectric material alternating layers having low and high refractive indices and terminating in a layer having a low refractive index.

According to another embodiment, the glass substrate is coated with at least one anti-fingerprint layer or is treated so as to reduce or prevent fingerprints from registering. This embodiment is also advantageous in the case of use of the glass substrate of the invention as front face of a touchscreen. Such a layer or such a treatment can be combined with a transparent and electrically conducting thin layer deposited on the opposite face. Such a layer can be combined with an antireflection layer deposited on the same face, the anti-fingerprint layer being on the outside of the stack and thus covering the antireflection layer.

According to still another embodiment, the glass substrate is coated with at least one layer or is treated so as to reduce or prevent glaring and/or sparkling. This embodiment is of course advantageous in the case of use of the glass substrate of the invention as front face of a display device. Such an anti-glare or anti-sparkling treatment is for example an acid-etching producing a specific roughness of the treated face of a portion or the whole area of the glass substrate.

The inner and/or outer surfaces can also comprise a printed coloured pattern and/or reflective pattern. Such printed patterns can also be applied to a surface of a glass lamina of a laminated glass substrate comprising at least a polymeric lamina sandwiched between two glass laminae.

Depending on the applications and/or desired properties, other layer(s) or treatment(s) can be applied to the inner and/or outer surface of the glass substrate of the present invention. For example, the outer surface can be treated against bacteria (e.g., with a layer of TiO₂, or Ag+ containing coating).

The layers and treatments of the surfaces of the glass surfaces can be applied by methods well known in the art. For example, a layer can be applied onto a surface by painting, sol-gel deposition, spin coating, dip coating, spraying, CVD/PVD, and the like.

Surfaces can be treated e.g. by ion implantation, corona treatment, laser treatment, etching, and the like. A corona treatment or a silane-based primer can be applied to enhance adhesion between the inner surface (1i) and the structured coating (2) or between the outer surface (1o) and an outer coating. All these treatments are very well known to a person of ordinary skill in the art, and the present invention is not restricted to any one thereof or to any alternative or similar treatments.

In an embodiment, the outer surface (10) of the glass substrate is covered by a polymeric protective layer, preferably a safety layer preventing the glass substrate from shattering in case of impact. This is particularly advantageous for applications in the transportation industry.

### Structured Coating (2)

The structured coating (2) is made of a polymer and is applied over all or part of the inner surface (1i) of the glass substrate. The structured coating forms an interface with the inner surface of the glass substrate, and comprises a free surface separated from the interface by a coating thickness (t2). The structured coating has a mean coating thickness (t2). Together with the glass substrate, the structured coating forms a coated substrate illustrated schematically in FIGS. 1(b) and 2.

The structured coating preferably has a mean coating thickness (t2) comprised between 0.1 and 4 mm, preferably between 0.5 and 3.5 mm, more preferably between 1 and 2.5 mm, more preferably between 1.2 and 2.0 mm. A mean coating thickness (t2) is defined because the thickness of the structured coating is not constant over the area thereof. The mean coating thickness (t2) can be such that a ratio t2/t1 of the mean coating thickness (t2) to the substrate thickness (t1) is comprised between 0.05 and 10, more preferably between 0.5 and 8, most preferably between 1 and 6, or even between 2 and 5, If weight is an issue (such as in air-transportation or even automotive vehicles), then the glass substrate must be thinner, thus pushing the ratio t2/t1 towards higher values. A thicker structured coating can also contribute to enhancing the mechanical resistance and safety properties of the coated substrate.

The free surface of the structured coating (2) is structured and has an Rz-roughness comprised between 0.1 and 4 mm, preferably between 0.5 and 3.5 mm, more preferably between 1. The Rz-roughness of the free surface is measured according to EN ISO 4287/A1 August 2009. A section of standard length (L) is sampled from the mean line on the roughness chart. As illustrated in FIG. 5, the distance between the peaks and valleys of the sampled line is measured in the z direction. Then, the average peak is obtained among 5 tallest peaks (Zpi), as is the average valley between 5 lowest valleys (Zvi). The sum of these two values is expressed in units of length (mm).

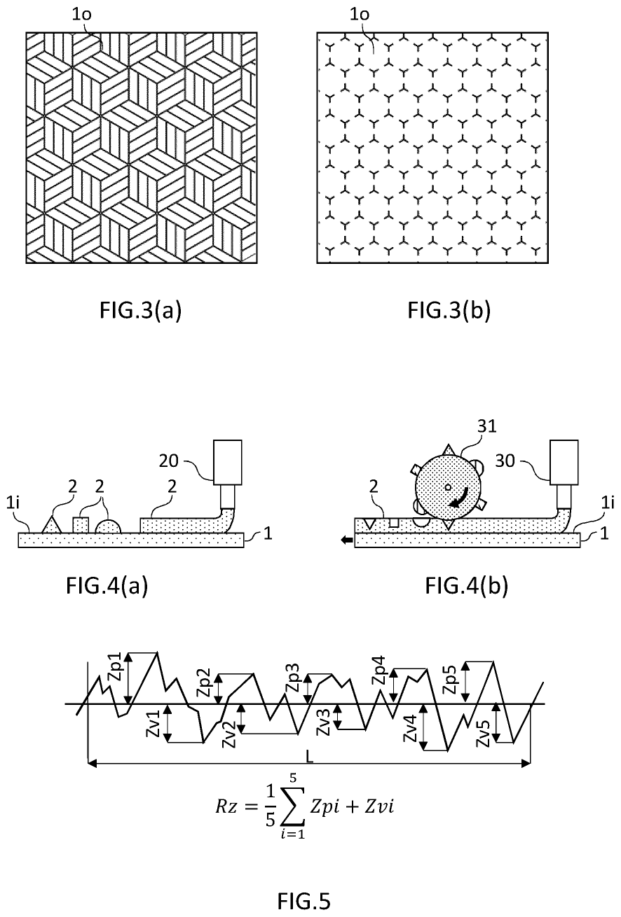

The free surface is structured defining a pattern which can be geometrically regular, to imitate a crystal-like cut-glass pattern as illustrated schematically in FIG. 2, or to yield a repetitive decorative pattern as illustrated in FIG. 3(a)&3(b).

The structured coating can cover a whole area of the inner surface (1i) of the glass substrate, such that the coating thickness is always greater than 0, and the structure is formed by recesses forming a pattern over the free surface. This embodiment is illustrated in FIG. 2(b).

Alternatively, the structured coating does not cover the whole area of the inner surface of the glass substrate. The structured coating can form lines or dots, protruding out of the inner surface of the glass substrate and/or can comprise one or more continuous islands covering a portion only of the area of the inner surface of the glass substrate, the free surface of the islands preferably comprising recesses forming a pattern. This embodiment is illustrated in FIG. 2(a). FIG. 1 illustrates schematically the structural coating forming lines or dots protruding out of the inner surface of the glass substrate with a cross-section in the shape of triangles, squares, and half-circles, and also islands comprising recesses depicted as the rectangle on the right hand-side of the glass substrate comprising triangular, square and half-circular grooves.

It is understood that a pattern in the context of the present invention can be a random pattern, a repetitive pattern, a geometrical pattern (not necessarily repetitive), a representation of a picture or drawing, and the like.

The structured coating is made of a polymer which cannot be opaque. Depending on the mean coating thickness (t2) of the structured coating, the polymer has a mean coating attenuation coefficient (a) of not more than 5000 m⁻¹ (i.e., a 5000 m⁻⁰, wherein the mean coating attenuation is an average measured between 380 and 780 nm. The attenuation coefficient (a) of the polymer can be lower in particular when a coating of higher mean coating thickness (t2) is applied. For example, the polymer can have an attenuation coefficient (a) lower than 2000 m⁻¹, or less than 1000 m⁻¹, preferably less than 500 m⁻¹, more preferably less than 100 m⁻¹. For decorative elements imitating a crystal-like cut-glass item or for applications as wave-guides, higher levels of transparency (i.e., lower values of absorbance) are preferred, and the polymer can have an absorbance of not more than 10 m⁻¹, preferably not more than 5 m⁻¹, or than 2 m⁻¹, more preferably not more than 1 m⁻¹. In some embodiments, it is possible to apply a non-homogeneous structured coating by integrating particles or even air bubbles to give a different aesthetic appearance to the decorative glass element.

The polymer forming the structured coating has a refractive index (n2), which shal not differ from the refractive index (n1) of the glass substrate by more than 0.2 (i.e., |n2−n1|≤0.2). A lower value of the difference, |n2−n1|, between refractive indices of the glass substrate and the structured coating yield a visual effect of continuity, as if the coated substrate were monolithic and the patterns defined by the structured coating were cut on the free surface of the glass substrate. The refractive indices difference |n1−n1| can be lower than 0.15, preferably lower than 0.1, more preferably lower than 0.05.

The polymer forming the structured coating can be selected for example among a polyester, a polyacrylic, an epoxy, a polyurethane, a polycarbonate, a silicone, or mixtures or copolymers thereof, or any polymer as listed in the Table supra.

The free surface of the structured coating can be coated with a reflective or coloured coating to enhance the decorative effect. A coloured coating gives an impression of stained-glass. A reflective coating can enhance the effect of a crystal-like cut-glass item. The coating can be continuous or can form a pattern, which can be printed on the free surface of the structured coating (2).

### Base Support (3)

The base support (3) comprises an interior surface (3i) facing with or without contact the free surface of the structured coating. It protects the free surface from direct access from the outer environment.

The base support (3) has several functions.
First it provides mechanical stability to the decorative glass element, in particular in flexion and torsion, as well as protecting the free surface of the structured coating from scratches.
Second, it can comprise fixing means for fixing the decorative glass element into position on a surface (e.g., a dashboard) provided with complementary fixing means. For example, the fixing means and complementary fixing means can be of the type hook/hole, hooks and loops (e.g., Velcro®), snap fitting elements, and the like.
Finally, the interior surface of the base support, which is visible by transparency through the glass substrate and structured coating, can contribute to the visual effect of the decorative glass element. For example, the interior surface can be opaque, transparent, or translucent. It can be coloured, reflecting like a mirror, thus enhancing the depth of the visual effect, or can comprise a pattern which interacts with the pattern formed by the structured coating to create original visual effects.

The base support (3) can be made of polymer, glass, metal, leather, woodor combinations thereof. If the base support is made of a polymer, it can be cast over the free surface of the structured coating so that the interior surface (3i) forms an interface with the free surface of the structured coating (2) and with any portion of the inner surface of the glass substrate which is not covered by the structured coating (cf. FIG. 1(e)). Any polymer can be used provided it adheres satisfactorily with the polymer of the structured surface. If necessary, the free surface of the structured surface can be treated to enhance adhesive compatibility with the polymer of the base support, such as a corona treatment or a primer.

In an alternative embodiment, the interior surface (3i) of the base support (3) does not contact (cf. FIG. 1(c)) or contacts only a portion of the free surface of the structured coating (cf. FIG. 1(d)), and is coupled to a peripheral edge of the glass substrate (1) and/or to a portion of the inner or outer surface (1i, 1o) of the glass substrate (cf. FIG. 1(c)&(d)), and/or to the portion of the free surface it contacts. The base support can be coupled to the coated substrate by any means known in the art. For example, it can be glued, welded, mechanically clamped, and the like;

### Process for Producing a Decorative Glass Element

A decorative glass element according to the present invention can be produced by a process comprising the following steps,
(a) providing a glass substrate (1) as defined supra
(b) applying a structured coating (2) as defined supra onto part or all of the inner surface (1i) of the glass substrate to form a coated substrate and, simultaneously or subsequently, forming a structured pattern on the free surface of the structured coating, having an Rz-roughness comprised between 0.1 and 4 mm, and
(c) coupling a base support (3) as defined supra to the coated substrate, such that the interior surface (3i) faces the free surface of the structured coating, and protects the free surface from direct access from the outer environment.

In a preferred embodiment, the structured coating is applied by 3-D printing with a 3-D printing head (20) the structured pattern onto the inner surface of the glass substrate as illustrated in FIG. 4(a). For example, a printer LEF-300 (available at Roland (France)) was successfully tested to apply onto the inner surface of a glass substrate a structured coating forming a pattern as illustrated in FIGS. 3(a)&3(b).

In an embodiment, the structured coating is applied by laminating and embossing a polymer layer over the inner surface of the glass substrate. For example, as illustrated in FIG. 4(b), a layer of polymer can be coated onto a glass substrate (1) through a nozzle (30) (which can be a 3-D-printing head (20)) or by any other technique commonly used for applying a polymeric layer onto a substrate, followed by an embossing station (31), which can be a roller which surface is provided with protrusions defining the negative of the structured pattern to be impressed into the free surface of the structured coating.

If the polymer is a thermoset polymer or an elastomer, embossing must be completed before the polymer is completely set (=cured). A curing station can be provided (not shown), including for example UV-lamps, a heating station (e.g., IR-lamps), and the like. If the polymer is a thermoplastic, embossing must be performed above Tg of the polymer. The cylinder can be heated to locally heat the thermoplastic polymer and/or a cooling station (not shown) can be provided downstream of the embossing station to freeze the thermoplastic polymer after embossing.

As discussed supra, the base support (3) can be coupled to the coated substrate by different means. If the base support is made of a base polymer, it can be cast in liquid state over the free surface of the structured coating (2) and over any portion of the inner surface (1i) of the glass substrate which is not covered by the structured coating. After solidification of the base polymer by cooling a thermoplastic polymer or by curing a thermoset polymer the base support is formed and solidly coupled to the coated substrate. A thus formed base support is illustrated in FIG. 1(e). The polymer can be transparent, translucent, or opaque. If it is transparent, it has a refractive index (n3) which preferably differs from the refractive indices of the glass substrate (n1) and of the structured coating (n2) by more than 0.3 (i.e., |n3−n1|>0.3, and (|n3|n2|>0.3). If the refractive index (n3) of the base support was closer to the one of the structured coating (n2), the decorative effect obtained by the pattern formed in or by the structured coating would be decreased.

In an alternative embodiment, the base support is coupled,
to a peripheral edge of the glass substrate (1) (cf. FIG. 1(f)), and/or
to a portion of the inner or outer surface (1i, 1o) of the glass substrate (cf. FIG. 1(c)&1(d)), and/or
to at least a portion of the free surface of the structured coating (2) (cf. FIG. 1(d)).

In this embodiment, the base support can be coupled to the coated substrate by anyone of gluing, welding, or mechanical locking.

As illustrated in FIG. 1(f), the decorative glass element can be permanently bent by cold bending upon coupling to the base support (3). This opens a multitude of decorative effects and applications in different fields of activity.

The present process is very advantageous in that it can be run semi-continuously, as it can be applied onto glass substrates of large dimensions, wherein the glass substrate has dimensions substantially larger than the desired dimensions of the individual decorative glass elements to be produced. For example, a glass substrate having several metres long edges could be used for producing several decorative glass elements having several decimetres long edges. The structured coating can be applied as described supra onto the whole area of such glass substrate of large dimensions to form a coated substrate of large dimensions. The base support can be coupled to the coated substrate over the whole area of the coated substrate. The thus obtained laminate of large dimensions can be cut into several individual decorative glass elements at the desired dimensions.

Alternatively, the coated substrate of large dimensions can be cut into individual coated substrates having the desired dimensions prior to coupling to the base support. Base supports of the desired dimensions can be coupled to the individual coated substrates to form the decorative glass elements of desired dimensions.

These methods reduce considerably the production cost of decorative glass elements, and are thus not restricted to luxury application anymore.

### Applications

A decorative glass element according to the present invention can be used in many applications. For example, and as discussed in the review section of the background art, there is a demand for such decorative glass elements in the automotive industry, for being integrated in an element of the interior of a vehicle, such as the dashboard, the central column with the controls and display of the computer, decorative elements on the doors, surrounding the shift stick or handbrake, and the like. Since the base support (3) can also be transparent, a decorative glass element according to the present invention can also be integrated in a portion of a window, including the windscreen and the side- or rear-windows. Since the base support can be transparent too, the decorative glass element can be back-lighted or side-lighted (waveguide) to give an additional decorative effect or can be used as glass covering a display panel.

The decorative glass element can also be used on an exterior of a vehicle, including the front or rear lights, trims elements such as a bumper or a B-pilar, the wheel hub cap, and the like. The same applies to any type of transportation means, including van, bus, lorry, boat, train, airplane, and the like.

The decorative glass element of the present invention can also be used in the building industry. Because for the first time, it is possible to cost-effectively produce decorative glass elements of large dimensions, they can be applied for giving new decorative effects to the interior or exterior of buildings. They can be applied on opaque panels, on panels which are back lighted, or can be integrated in windows of a building.

Since the decorative model for the decorative glass elements of the present invention are crystal glassware and lamps, an obvious application of the present invention is for reproducing glasses, jars, bottles, lamps, and the like, to make them look like cut-glass crystal glassware.

The decorative glass element of the present invention can also be used for decorating electrical appliances. In particular, many electrical appliances, such as washing machines, dishwashers, robots (including mixers, vacuum cleaners, lawnmowers, etc.), fridges, ovens (conventional or microwave), vitroceramic cooktops, coffee machines, and the like have a display and/or a control panel comprising glass (or polymer) sheets. These sheets can be replaced by a decorative glass element according to the present invention.

The present invention allows, on the one hand, to provide decorative glass elements looking like cut-glass crystal items at a substantially lower cost and, on the other hand, to provide new territories for developing different decorative effects never explored to date. Because the production of the decorative glass elements of the present invention can be semi-continuous, hand-made decorative elements used exclusively in luxury applications can now be implemented at a larger scale in consumers goods.

The gist of the present invention is to replace the pattern formed by a cut-glass surface of a traditional crystal item by an easily mouldable polymeric structured layer, and to keep the feeling of a glass item by exposing the outer surface of the glass substrate to contact from the outer environment. At the same time, the softer free surface of the structured coating and the 3-D-pattern defined thereby is protected from wear and from any contact from the outer environment by facing the free surface to the base support. The decorative glass element of the present invention therefore combines,
The decorative effect of a cut-glass item,
The feeling of a cut-glass item,
The wear resistance of a glass item, and
A production cost which is substantially lower than a corresponding cut-glass item.

| REF# | Feature |
|---|---|
| 1 | Glass substrate |
| 1i | Inner surface of the glass substrate |
| 1o | Outer surface of the glass substrate |
| 2 | Structured coating |
| 3 | Base support |
| 3i | Interior surface of the base support |
| 20 | 3-D-printing head |
| 30 | nozzle |
| 31 | Embossing station |
| 20 | 3-D printing head |
| n1 | Refractive index of the glass substrate |
| n2 | Refractive index of the structured coating |
| n3 | Refractive index of a transparent base support |
| Zpi | 5 tallest peaks |
| Zvi | 5 deepest valleys |

1. A decorative glass element comprising:
a glass substrate, having a refractive index (n₁), comprising an outer surface exposed to an outer environment and being separated from an inner surface by a substrate thickness (t₁), and being transparent to visible light with a substrate transmission (T₁) across the substrate thickness of at least 30%, wherein the transmission is measured according to EN410-2011 with a D-illuminant and a solid angle of observation of 2°;
a structured coating applied over all or part of the inner surface of the glass substrate, forming an interface with the inner surface of the glass substrate, and comprising a free surface separated from the interface by a coating thickness having a mean coating thickness (t₂), thus forming with the glass substrate a coated substrate, wherein
the free surface has an R_{Z}-roughness between 0.1 and 4 mm, and
the structured coating is made of a polymer, wherein the polymer,
has a refractive index (n₂) differing from the refractive index (n₁) of the glass substrate by not more than 0.2 (i.e., |n2−n1|≤0.2), and
has a mean coating attenuation coefficient (a) of not more than 5000 m⁻¹ (i.e., a ≤5000 m⁻¹), wherein the mean coating attenuation is an average measured between 380 and 780 nm; and
a base support coupled to the coated substrate, comprising an interior surface facing with or without contact, the free surface of the structured coating, and protecting the free surface from direct access from the outer environment.

2. The decorative glass element according to claim 1, wherein
the substrate thickness (t₁) is comprised between 0.4 and 2 mm, and/or
the mean coating thickness (t₂) is between 0.1 and 4 mm, and/or
a ratio t₂/t₁ of the mean coating thickness (t₂) to the substrate thickness (t₁) is between 0.05 and 10.

3. The decorative glass element according to claim 2, wherein the glass substrate
is chemically strengthened, and/or
is a laminated glass comprising at least a polymeric lamina sandwiched between two glass laminae.

4. The decorative glass element according to claim 1, wherein the outer surface of the glass substrate is covered by a polymeric protective layer.

5. The decorative glass element according to claim 1, wherein the polymer forming the structure surface is is selected from the group consisting of a polyester, a polyacrylic, an epoxy, a polyurethane, a polycarbonate, a silicone, or mixtures and copolymers thereof.

6. The decorative glass element according to claim 1, wherein the free surface of the structured coating is coated with a reflective or coloured coating.

7. The decorative glass element according to claim 1, further comprising a coloured pattern and/or a reflective pattern printed on a surface of the decorative glass element, wherein the surface is:
the inner surface of the glass substrate,
a surface of a glass lamina of a laminated glass substrate comprising at least a polymeric lamina sandwiched between two glass laminae,
the free surface of the structured coating, or
combinations thereof.

8. The decorative glass element according to claim 1, wherein the base support (3) is made of polymer, glass, metal, leather, wood, or combinations thereof.

9. The decorative glass element according to claim 8, wherein the base support is made of polymer and the interior surface of the base support forms an interface with the free surface of the structured coating and with any portion of the inner surface of the glass substrate which is not covered by the structured coating.

10. The decorative glass element according to claim 8, wherein the interior surface of the base support does not contact the free surface of the structured coating, and is coupled to a peripheral edge of the glass substrate and/or to a portion of the inner or outer surface of the glass substrate.

11. A method for producing the decorative glass element according to claim 1 comprising:
providing the glass substrate,
applying the structured coating onto part or all of the inner surface of the glass substrate to form the coated substrate, and forming the structured pattern on the free surface of the structured coating, having an R_{Z}-roughness between 0.1 and 4 mm, and
coupling the base support to the coated substrate, such that the interior surface of the base support faces the free surface of the structured coating, and protects the free surface from direct access from the outer environment.

12. The method according to claim 11, wherein forming the structured pattern is performed by 3-D printing of the structured pattern onto the inner surface of the glass substrate, or by laminating and embossing a polymer layer over the inner surface of the glass substrate.

13. The method according to claim 11, wherein the base support is made of a base polymer which is cast in liquid state over the free surface of the structured coating and over any portion of the inner surface of the glass substrate which is not covered by the structured coating, followed by solidifying the base polymer by cooling or by curing the base polymer.

14. The method according to claim 11, wherein the base support is coupled to a peripheral edge of the glass substrate and/or to a portion of the inner or outer surface of the glass substrate, and/or to at least a portion of the free surface of the structured coating, the coupling being carried out by gluing, welding, or mechanically.

15. The method according to claim 11, wherein the decorative glass element is permanently bent by cold bending upon coupling to the base support.

16. (canceled)

17. The decorative glass element according to claim 3, wherein the glass substrate is flat.

18. The decorative glass element according to claim 1, wherein
the substrate thickness (t₁) is between 0.5 and 1.5 mm, and/or
the mean coating thickness (t₂) is between 0.5 and 3.5 mm, and/or
a ratio t₂/t₁ of the mean coating thickness (t₂) to the substrate thickness (t₁) is between 1 and 6.

19. The decorative glass element according to claim 1, wherein
the substrate thickness (t₁) is between 0.6 and 1.2 mm, and/or
the mean coating thickness (t₂) is between 1 and 2.5 mm, and/or
a ratio t₂/t₁ of the mean coating thickness (t₂) to the substrate thickness (t₁) is between 2 and 5.

20. The decorative glass element according to claim 2, wherein the glass substrate
is chemically strengthened, and/or
is a laminated glass comprising at least a polymeric lamina sandwiched between two glass laminae.

21. The decorative glass element according to claim 8, wherein the interior surface of the base support contacts only a portion of the free surface of the structured coating, and is coupled to a peripheral edge of the glass substrate and/or to a portion of the inner or outer surface of the glass substrate.
